(19) United States
(12) Patent Application Publication
(10) Pub. No.: US 2024/0256681 A1
(43) Pub. Date: Aug. 1, 2024

(54) RESTRICTED DATABASE ACCESS IN WEB APPLICATIONS

(71) Applicant: Dell Products L.P., Round Rock, TX (US)

(72) Inventors: Seth Jacob Rothschild, Littleton, MA (US); Rana Afifi, New Cairo (EG)

(21) Appl. No.: 18/159,867

(22) Filed: Jan. 26, 2023

(51) Int. Cl. G06F 21/60; G06F 21/62

(52) U.S. Cl. CPC G06F 21/604; G06F 21/6218; G06F 2221/2113; G06F 2221/2141

(57) ABSTRACT

One example method includes receiving, by a policy layer from a webapp, user information and a database request that identifies a database, obtaining, by the policy layer, information identifying database access rights for a user who transmitted the database request to the webapp, generating, by the policy layer, a credential for the user, and returning, by the policy layer, the credential to either the user or to the webapp. The user may then use the credential to access the database.

### FIELD OF THE INVENTION

Embodiments of the present invention generally relate to database security. More particularly, at least some embodiments of the invention relate to systems, hardware, software, computer-readable media, and methods, for managing database access by a web application.

### BACKGROUND

When developers write a web application that requires access to a database, the current best practice is for the web application to have its own set of database credentials that provide unlimited access to the contents of the database. This approach is simple on its surface, and databases can have excellent performance when the same connection is always used to query the database. In this approach however, each individual webapp developer must carefully protect the database credentials, and must also be extraordinarily careful while writing the app backend, so as to ensure that users do not have more rights and access, with respect to the database, than they need.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example method and architecture according to one embodiment.

FIG. 2 discloses aspects of a UI, according to one embodiment, displaying various information concerning database access to a user.

FIG. 3 discloses aspects of a UI, according to one embodiment, displaying various information concerning database access to a user.

FIG. 4 discloses aspects of a UI, according to one embodiment, displaying various information concerning database access to a user.

FIG. 5 discloses aspects of an example method according to one embodiment.

FIG. 6 discloses aspects of an example computing system that is configured and operable to perform any of the disclosed methods, processes, and operations.

### DETAILED DESCRIPTION OF SOME EXAMPLE EMBODIMENTS

Embodiments of the present invention generally relate to database security. More particularly, at least some embodiments of the invention relate to systems, hardware, software, computer-readable media, and methods, for managing database access by a web application.

In general, an embodiment of the invention may comprise a method for managing database access outside of a web application, also referred to herein as a ‘webapp,’ and moving these security responsibilities from the webapp developers to security professionals. An embodiment may implement this functionality by requiring that each user have individual, that is, user-specific, credentials that grant that user database access which allows the user to only perform certain defined actions and operations with respect to the database. Thus, a user may be constrained in terms of their access to, and use of, the database. Put another way, in an embodiment, access to, and use of, a database may be defined and implemented on a user-level basis, rather than on a webapp basis as in conventional approaches. Thus, an embodiment may comprise a zero-trust implementation, and may separate security concerns from the development of a webapp experience, so that security operations concerning a database to be accessed by the webapp may be directed to a team better equipped and qualified to handle those security concerns.

One example embodiment may operate generally as follows. Initially, a user may access a page of a webapp. User actions, such as visiting the page and clicking buttons may trigger backend events involving a database. In an embodiment, the webapp may not have to make any determination as to whether or not the user should be able to access a particular database and database content. Instead, the webapp may simply employ personal credentials of the user to query the database and obtain from the database whatever the user credentials indicate is permitted. The credentials may be pre-scoped by the policy engine to only allow the user to view and/or otherwise access whatever database content the user is authorized to. In an embodiment, the webapp may make UX (user experience) changes to the page to only show the user those materials and items that the user is authorized, as defined by the user credentials, to access. This is why, in an embodiment, the policy engine may respond to a request for credentials with information about the role of the user, so that the webapp may make user interface changes based on the information provided by the policy engine.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a webapp need not have to make security and database access privilege determinations concerning a user who is using the webapp and may need access to a database as a consequence of that use. An embodiment may implement a user-specific database access approach such that each user of a particular webapp may be granted particular access to a database employed by the webapp according to the respective credentials of the user. An embodiment may eliminate the need for a webapp developer to control database access by users of the webapp. Various other advantages of some embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for Some Example Embodiments of the Invention

Webapps, in connection with which an embodiment of the invention may be employed, are ubiquitous. For the purposes of illustration, some examples of webapps include Gmail, GoogleDocs, MS Office 365, Amazon, Facebook, and WhatsApp.

As will be apparent from this disclosure, and as introduced above, one or more embodiments of the invention may comprise functionalities that may prove useful in view of various circumstances that exist in the art. For example, an embodiment may eliminate the need for webapp developers to write code to prevent unauthorized database access by users of the webapp. Particularly, it may be complex to manage user roles with an application, and to protect the database connection string, that is, the route(s) by way of which the database may be accessed. Thus, an embodiment of the invention may effectively remove these responsibilities from the webapp developer. More particularly, an embodiment of the invention may operate so that the security responsibility concerning database access is removed from developers, such that role management becomes a UX matter. To illustrate, if the developer shows the user a page that the user should not be able to see, or have access to, then the data loaded to that page could be limited, based on the user credentials, and/or buttons in the webapp might not work since the user does not have certain database permissions. In this way, the user would not get more information than they should, as defined by the policy engine.

As another example, an embodiment may comprise functionality that addresses a circumstance in which a database may rely on application logic for fine-grained database access authorization. Particularly, from the perspective of the database, since an application such as a webapp typically accesses the database through a single connection string or password for all users, the database cannot control any fine-grained authorization for application users as the users all appear, to the database, as constituting a single user. This means that a database would be unable to enforce zero-trust policies since, for normal operation, the database must trust every request from the webapp.

A further example of the applicability of the functionality of an embodiment of the invention concerns a circumstance in which a malicious user manages to gain unauthorized access to the database credentials and, thereby, automatically gains access to the associated database. That is, when an attacker gains access to an application, then the attacker ultimately gains access to the database since the application uses a single method for database access regardless of the user. Worse, from the perspective of the database, such an attack appears as a normal database access by a user and, thus, detection of the breach is difficult. As a result, the attacker has access to the database unless/until the password is changed, and it is difficult to tell where the leak happened. Accordingly, in an embodiment of the invention, user database access credentials may be managed by a policy engine, tied to a specific user, and expire automatically. Thus, an attacker who steals user credentials would only get access to what that particular user has access to, that access would be well documented, and the unauthorized access would be terminated, at the latest, when the stolen user credential expires.

A final example of the applicability of the functionality of an embodiment of the invention concerns a circumstance in which a malicious application gives unauthorized users full access to the database. Since the application stores the database credentials/connection string, the malicious application can inherently abuse these privileges, and/or compromise the access logic to give unauthorized users full access to the database. Thus, breach is the default state in the circumstance where a webapp has a single credential string while, in one embodiment of the invention, an attacker would have to add code to steal credentials from a particular user in order to gain access to the database.

### B. Overview

As noted herein, a web application, or ‘webapp,’ or simply ‘app,’ typically has the information for that application in an associated database. To access that database, the app itself has credentials which can access everything in the database. Following best practices, these all-powerful credentials may be completely hidden from the developer. On the surface, this may seem to be a reasonable and simple solution for database access. For example, not only can the app always do everything it needs to do in the database, but keeping a single connection open is less computationally expensive than opening a respective connection for each individual user.

However, there are some subtle downsides that experienced developers may be familiar with. One of these is that developers often become responsible for protecting the all-powerful database access credentials. Even if using products such as the Hashicorp Vault (https://www.hashicorp.com/products/vault), the developer is still responsible for learning and implementing the additional complexity of configuring their app correctly to use these systems so as to avoid leakage of the database access password. Another consideration is that there is enormous complexity in managing roles in the backend code, that is, the code that communicates with the database. Since the app itself can access everything, the developers are typically responsible for writing code to prevent unauthorized access to the database(s). Further, when a breach occurs, it is not possible to detect from the database which user is creating the unauthorized access, just that the query has happened. As such, the app itself needs sufficient logging to determine who is doing what, and to track down the malicious entity that gained access to, or attempted to gain access to, the database. It may be preferable however that these should not be developer responsibilities and, in an embodiment, the security of the whole app may be improved by moving those responsibilities to security experts. Thus, an embodiment may comprise a process in which each user receives their own respective database credentials and role management may be handled by a policy engine owned and controlled by a security team.

### C. Detailed Discussion of Some Example Embodiments

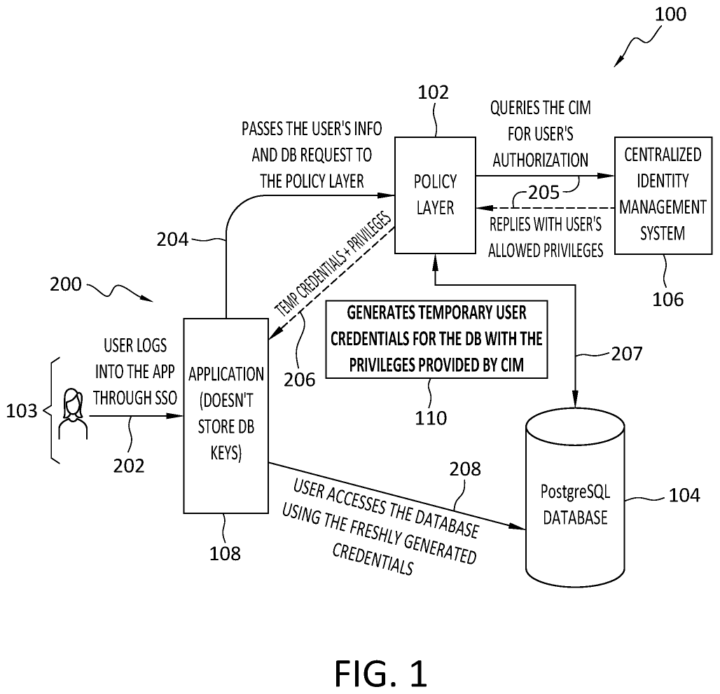

In general, an embodiment may, rather than using a single set of credentials, comprise a method in which the application talks to a policy layer which distributes individual access to the database user by user. With reference now to FIG. 1, details are provided concerning aspects of an example embodiment of the invention.

### C.1 Some Components of an Example Embodiment of the Invention

As shown in the example architecture 100 of FIG. 1, an embodiment of the invention may comprise various components. One of the components may be a policy layer 102 that comprises a policy engine. Any of the disclosed functionalities of the policy layer 102 may be performed in whole, or in part, by the policy engine. Among other things, the policy layer 102 may be configured, and operate, to manage user-database credential pairs. In particular, the policy layer 102 may be aware of [1] which user(s) 103 may have access to a database 104, [2] when that access should expire, and the policy layer 102 may [3] be able to create new credentials for a given user. Note that none of the aforementioned components is required to be hosted at, accessible by, located at, or operate at, any particular site. In an embodiment, for example, the policy layer 102, or instances of the policy layer 102, may be implemented at an enterprise level, or locally at a user level. As another example, the centralized identity management system 106 may be implemented at an enterprise level so that it is accessible by multiple webapps 108 which may be operating at an enterprise level.

An embodiment of the invention may further comprise a centralized identity system 106 that may be responsible to store state information. This state information may indicate, for example, what user(s) 103 have what access to the database 104, which users 103 should be allowed to request access to the database 104, and when that access should expire. Access may specified for a specific amount of time, such as 1 hour for example, or may be specified to end at a particular time, such as at 1100 on Jan. 10, 2023.

As further indicated in FIG. 1, a webapp 108 may communicate with the policy layer 102, request database credentials from the policy layer 102 on behalf of the user 103, and then either use, or pass through, database credentials 110 to the user 103. The user database credentials 110 may be generated by the policy layer 102 based on information received from the centralized identity management system 106. Note that, in an embodiment, the webapp 108 does not store any credentials to the database 104 in advance, and cannot access, or grant access to, the database 104 without the involvement of the policy layer 102.

With further reference to the database 104, the database 104 may generally comprise a database, associated with a webapp, to which the user 103 requests access to and for access to which the policy layer 102 may create temporary, user-specific, credentials for the requesting user 103 using the information retrieved from the database 104. It is noted that the database 104 may be able to create new credentials, and modified credentials, either or both of which may define a respective specific role and limited access.

C.2 Removed Responsibilities from App Developers

Rather than having to attempt to securely manage a connection string for a database in the configuration of the app, developers may, when an embodiment of the invention is employed, only need to include an HTTPS link, in the webapp 108, to the policy layer 102. An example user flow 200 may proceed as follows.

Initially, a user 103 may visit 202 a webapp 108 login page and click ‘login.’ In an embodiment, the user 103 may log in through SSO (single sign-on) and receives a token in response. The webapp 108 may then send 204 that token to the policy layer 102 endpoint. If the user 103 should have access to the database 104 and no credentials exist for the user 103, temporary credentials may be created by the policy layer 102 to allow the user 103 to access the part of the database 104 they should have access to according criteria in the policy layer 102. The policy layer 102 may be responsible for determining, such as by communicating 205 with the centralized identity management system 106, the access the user 103 should have and requesting credentials 110 for that access from the database 104. The policy layer 102 may also be responsible for informing 206 the webapp 108 what database 104 access the user 103 should have. In other words, in an embodiment, the webapp 108 makes no decision about what access a user 103 should have and, instead, the webapp 108 simply queries 204 the policy layer 102 and the policy layer 102 returns 206, in response to the query 204, the appropriate user credentials.

According to the user 103 privileges, which may be obtained 205 by the policy layer 102 from the centralized identity management system 106, or from the database 104, the policy layer 102 may create ephemeral credentials to the database 104 so that the user 103 is only able to access the database 104 with their allowed privileges for a given period of time. The policy layer 102 may then respond 204 to the webapp 108 with the freshly-generated credentials as well as the roles of the use, so that the webapp uses those credentials and role information, during the specific time interval, to grant the user 103 limited access 208 to the database 104.

In an embodiment, the policy layer 102 may communicate 207 with the database 104 to determine what credentials can be created for the user 103. The policy layer 102 may also communicate 207 with the database 104 to determine what access can be permitted to the user 103. Thus, in an embodiment, the policy layer 102 may communicate 207 with the database 104, and/or communicate 205 with the centralized identity management system 106, to determine the nature of the access privileges that have been granted for the user 103.

### C.3 Further Responsibilities for an Embodiment of the Policy Engine

While an embodiment may reduce webapp development complexity for developers, a policy layer 102 and the maintainers of the policy layer 102 may correspondingly assume various responsibilities relating to webapp user database access. Some examples of such responsibilities are set forth below.

For example, a policy layer 102 may know what user roles exist within the webapp 108, and the policy layer 102 may have sufficient privileges in the database 104 to create new user credentials that define and include those privileges. In an embodiment, the policy layer 102 may gain an understanding of who a user 103 is by querying the centralized identity management system 106.

As well, the policy layer 102 may, in an embodiment, be frequently queried during all webapp 108 activity, since each user 103 may need to be individually checked and authorized. This may be relatively computationally intensive compared to a conventional approach that uses only a single sign on credential for all users. Thus, in an embodiment, running the policy layer 102 may be relatively more expensive, in terms of computing resource consumption, than conventional approaches.

Further, in an embodiment, the policy layer 102 may be responsible for communicating securely with the webapp 108 in a standard form, such as JSON (javascript object notation) or YAML (YAML ain't markup language) over HTTPS (Hypertext Transfer Protocol Secure) with information about how long the credentials will persist and what the credentials are good for, that is, what permitted activity is specified, or implied, by the credential. This may enable the webapp 108 to display a correct user interface for the user 103. That is, the credential may enable the webapp 108 to present one or more user-specific displays, such as by way of a GUI (graphical user interface) or CLI (command line interface) for example, where the particular display, including its form, content, and functionality, is based on the respective individual user credentials.

In an embodiment, the policy layer 102 may be responsible for safe secret storage and management that a developer may previously have been responsible for. Note that the conventional “single credential” weaknesses of webapps may still apply if an attacker were to be able to steal the primary database 104 credential from the policy layer 102. A role of the policy layer 102 in a security context is to enforce rules. As such, policy engines may be attractive targets for malicious users, since if an attacker controls the rules-making platform, the attacker may be able to access everything, and also prevent access by others. Thus, an embodiment may relieve developers of the responsibility for handling the all-powerful database connection, and may enable assumption of that responsibility by a team that is better prepared to do so securely.

### C.4 Aspects of an Example Application Flow

In a conventional approach, a webapp flow may proceed as follows: [1] the user accesses a page—visiting the page and additional javascript events can trigger backend actions; [2] the webapp determines if the user is authorized to access a given backend action and if so carries it out—the app uses its own credentials to query the database on behalf of the user; and [3] optionally, the UX of the page might prevent a user from clicking a certain button or prevent a user from visiting a certain page—this is a secondary security concern from protecting the backend action, since any backend route can be queried by any browser. In contrast, a webapp application flow according to one embodiment is substantially different from what has just been described.

In particular, once the user has logged in and gotten their personal database credentials: [1] the user accesses a page using the webapp—this accessing may comprise visiting the page and clicking buttons that may trigger backend events; [2] the webapp makes no determination as to whether or not the user should be able to hit a particular route or access to the database and, instead, may simply use the personal credentials of the user to query the database and return to the user whatever database content is permitted by and/or associated with the personal credential of the user—the user-specific credential may be pre-scoped by the policy engine to only enable the user to view whatever database content has been authorized for that user; and [3] the webapp may make UX changes to the page accessed by the user to show the user only those items, such as images, files, other content, and functions, for example, that are permitted by their credentials.

Thus, a policy engine according to an embodiment may respond to a request for credentials with information about the role of the user, so that the webapp may make user interface changes based on the information. Note that it is not required that UX changes be made in response to a credential request, and in some embodiments, certain functions, for example, may simply be disabled so that they cannot be invoked by the user. In such a case, the UI may nonetheless appear to the user as if all functions and database content were available to the user. Thus, even if the developer does nothing to hide pages and change the UX based on role, since individual users do not have access to parts of the database that they should not, the user request may simply result in a broken experience rather than data loss, that is, rather than a loss of access, by the user, to data in the database.

### C.5 Change in Development Flow

As an app is built, and changed, the database associated to that app may change with the database. In some circumstances, developers may have to make emergency changes to data by hand. It will be appreciated that an embodiment of the invention may intentionally make such hand data changes more difficult.

In particular, an embodiment may require additional communication about roles an operational flow such that developers and maintainers of the policy engine may need to communicate about roles and the access that those roles should have during the app development so that those roles can be appropriately implemented in the engine. An embodiment may prevent a developer from making changes, directly in the database, to who has access to what. Note that, absent implementation of an embodiment of the invention, such decisions about roles and data access may be handled in house by a development team, instead of by a security team.

### C.6 Corner Cases

As is currently the case, that is, absent implementation of an embodiment of the invention, a malicious developer could write code to authenticate himself as any user to the database. This may be possible whether or not an embodiment of the invention is implemented, and absent such implementation, conventional with and without this invention and may be avoided, in some circumstances at least, by the use of code review processes, and limitations on what changes can be pushed to production.

However, where an embodiment of the invention is implemented, the task of the attacker may be more complicated, as the attacker would have to add new code to the system to steal credentials from real users instead of removing code that is securing routes to the database. Moreover, an embodiment of the invention may ensure that those credentials would automatically expire and, as such, a malicious developer will not have indefinite access to the database.

In an embodiment, the personal, or user-specific, credentials may be handled in various ways. For example, the personal database credentials may be provided directly to a user, or the webapp may hold the user credentials. Since the app needs to operate on the database data, it is reasonable for the app to manage the credentials for the user, but in cases where less manipulation is needed, it may be reasonable to bypass the app and explicitly give the credentials directly to the user, thus potentially giving the user more control over their data since the user does not have to obtain her credentials from the webapp.

### D. Further Discussion

As will be apparent from this disclosure, one or more embodiments of the invention may possess various useful features and advantages. A non-exhaustive list of these is set forth below.

For example, an embodiment may comprise a method to create, within a webapp, ad-hoc user specific credentials for database access. When a user attempts to connect with the database through the webapp, the webapp may requests credential for that user from a policy layer. These credentials may be created to give the user only a restricted set of privileges, as stipulated by the policy engine. Thus, the webapp may be designed so that it is not required to store an all-powerful credential that can be employed by all webapp users, or have indefinite access to the database. In an embodiment, each request for access to the database may depend on the current user requesting it.

As another example, an embodiment may comprise a method to communicate, such as by a webapp for example, with a policy engine to define and distribute database access and role status for users of the webapp. A policy engine according to an embodiment may send [1]information about a user role within an app and [2] credential duration when the app requests credentials for a user. In a zero trust system according to one embodiment, a single source of truth for users privileges may comprise a centralized identity management system. Thus, when an embodiment operates to retrieve, through a policy layer, the user privileges, for all webapps, from the centralized identity management system, then the respective roles for each users may be guaranteed to be unified and correctly implemented across the system.

In a final example, an embodiment may comprise a method to implement fine-grained authorization, such as at an individual user level, on a database where access is determined by a policy engine rather than manually by application developers, or by a webapp. Thus, an embodiment may be advantageous at least insofar as a policy engine may be able to generate credentials for database access for each user. By way of contrast, conventional approaches only provide for manual distribution of credentials, and such credentials are not employed within the context of a webapp.

An embodiment may find particular use in an enterprise where webapps with a single database credential are found. A single database credential, particularly one secured mostly by developers, is a liability and limits the amount of data that can be collected as would be required for zero trust. Thus, an embodiment may be useful for enterprises that use infrastructure as an alternate way to build webapps.

### E. Aspects of Some Example Use Cases

One example prototype case may serve as a test for an embodiment and to improve understanding of considerations relating to the removal of the single credential string, as is employed in conventional approaches. This particular prototype was implemented in connection with a Python web pp to represent the application that users log into to access the databases. In this use case, a user first logs into the web app using SSO, and the user then views a list of available databases in the system. Once the user clicks on a database to access, the web app then forwards the requester information and the requested database name to the policy layer which, in this prototype, is a simple class callout, whereas in an actual use case, the policy layer may comprise a separate service.

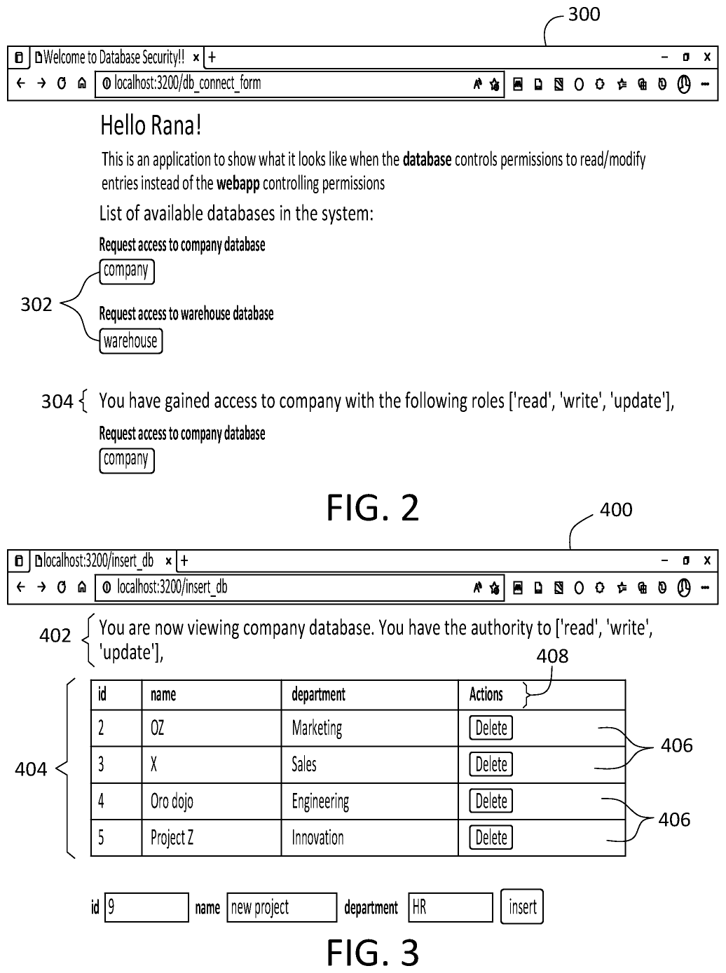

The policy layer the queries the centralized identity management system. This system stores the usernames and their corresponding privileges for each of the available databases in the system. The policy layer then accesses the requested database to create a temporary user role which matches the role privileges of the requester, or user. As shown in the example screenshot of a UI (user interface) 300 in FIG. 2, the policy layer then replies with the credentials for this role to the webapp. In particular, in FIG. 2, role access to the database has been granted by the policy engine, rather than by the webapp itself. In this example, the user has requested access to one database, and gained access to that database.

On the web app view, shown in FIG. 2, one or more buttons 302 appear which allows the user to access the requesting database with their privileges. Each button 302 may correspond to a different respective webapp database. Upon clicking one of the buttons 302, access to the requested database is confirmed by the message 304, and the user is then able to view the database according to the privileges specified in the user role for that user.

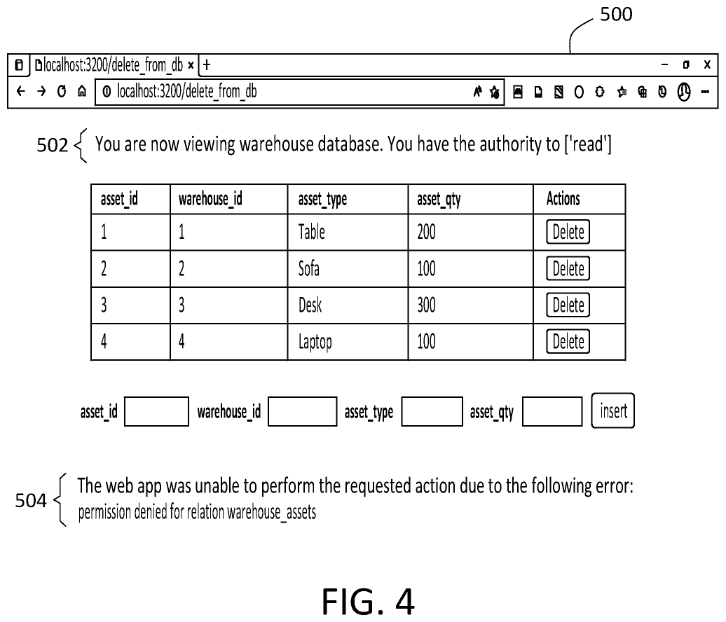

As shown in the screenshot of an example UI 400 in FIG. 3, a user may have read-write-update privileges to the database, as shown by the message 402, so he is able to insert new data, and modified data, into the database, and also delete data from the database. As shown in the example UI 400, a list 404 of entries 406 in the selected database may be displayed to the user, and permitted actions 408 concerning those entries. In contrast with the user privileges identified by the message 402 in the UI 400, a screenshot of a UI 500 disclosed in FIG. 4 displays a message 502 indicating that the user has read-only privileges with respect to the database to which access was granted, and a message 504 indicates that a delete operation attempted by the user was rejected, and not performed. In particular, when the user tried to delete a row, the UI displayed an error in the webapp because the database rejected the transaction based on the privileges identified in the user credentials. That is, the privileges identified in the role for that user do not permit the user to delete data from the database.

### F. Example Methods

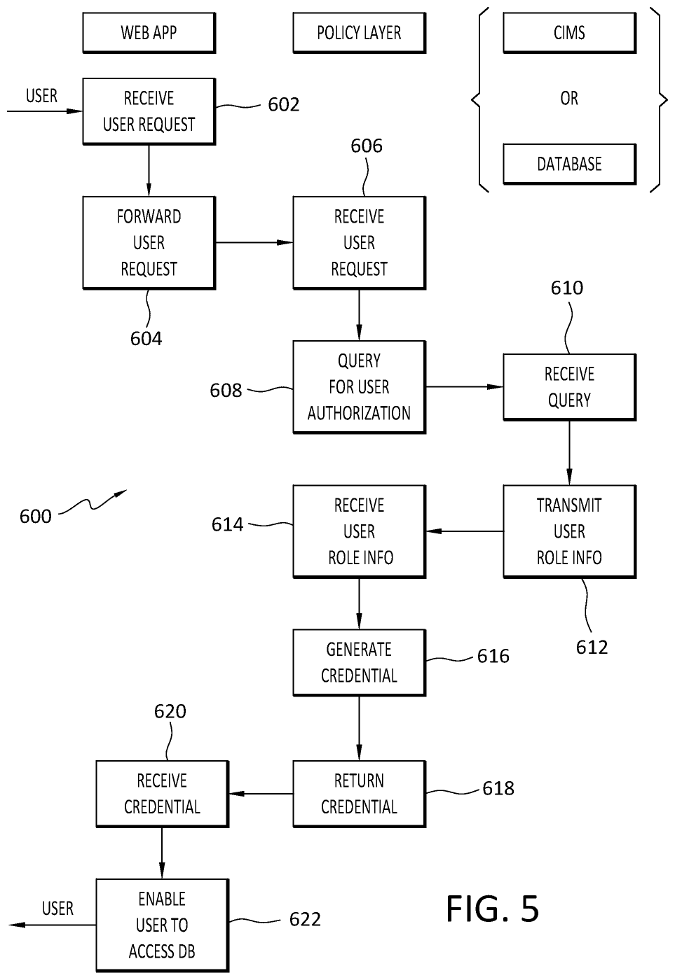

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 5, an example method according to one embodiment is denoted generally at 600. In an embodiment, part, or all, of the method 600 may be performed at any site where data is stored. Such sites may include, for example, a laptop or other personal computer, an enterprise site, and a cloud data storage site. A webapp, or instance of a webapp, by way of which a user may request access to a database may be hosted locally on a user computing system, or in a remote location accessible by a user.

The example method 600 may begin at 602 with receipt, such as by way of a webapp UI, of a user request to access a database associated with the webapp. Since, in an embodiment, the webapp does not create or maintain user access credentials, the webapp may forward 604 the request to a policy layer, which may then receive 606 that request.

The policy layer may then query 608 a centralized identity management system (CIMS), or the database to which the user has requested access. The query 608 may request information about a user role for the user who requested access to the database. The user role may specify the privilege(s) that the user has been granted with respect to that database. The CIMS, or the database, as applicable, may receive 610 the query, and then return 612 the user role information.

The policy layer may receive 614 the role information transmitted 612 by the CIMS or database. The policy layer may then use the role information to generate 616 a credential for the requesting user that identifies the privileges that have been granted to the user. The credential may then be returned 618 by the policy layer to the webapp. The webapp, or in some cases, the user, may then receive 620 the credential. The user may then employ 622 the credential to access the database, according to the privileges that have been defined for the user.

### G. Further Example Embodiments

Following are some further example embodiments of the invention. These are presented only by way of example and are not intended to limit the scope of the invention in any way.

Embodiment 1. A method, comprising: receiving, by a policy layer from a webapp, user information and a database request that identifies a database; obtaining, by the policy layer, information identifying database access rights for a user who transmitted the database request to the webapp; generating, by the policy layer, a credential for the user; and returning, by the policy layer, the credential to either the user or to the webapp.

Embodiment 2. The method as recited in any of the preceding embodiments, wherein the credential includes the user privileges.

Embodiment 3. The method as recited in any of the preceding embodiments, wherein when the user uses the credential, the user is granted access to the database, and the access is constrained by the user privileges.

Embodiment 4. The method as recited in any of the preceding embodiments, wherein the credential is specific to the user.

Embodiment 5. The method as recited in any of the preceding embodiments, wherein the webapp is configured to use user privilege information in the credential to change what is displayed to, and/or selectable by, the user.

Embodiment 6. The method as recited in any of the preceding embodiments, wherein the information identifying the database privileges is obtained by the policy layer from either the database, or from a centralized identity management system.

Embodiment 7. The method as recited in any of the preceding embodiments, wherein the credential expires automatically after a period of time.

Embodiment 8. The method as recited in any of the preceding embodiments, wherein the credential is generated ad hoc in response to the database request.

Embodiment 9. The method as recited in any of the preceding embodiments, wherein the credential is specific to the user, the webapp, and to the database.

Embodiment 10. The method as recited in any of the preceding embodiments, wherein the webapp makes no determination as to whether or not the user is granted access to the database.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

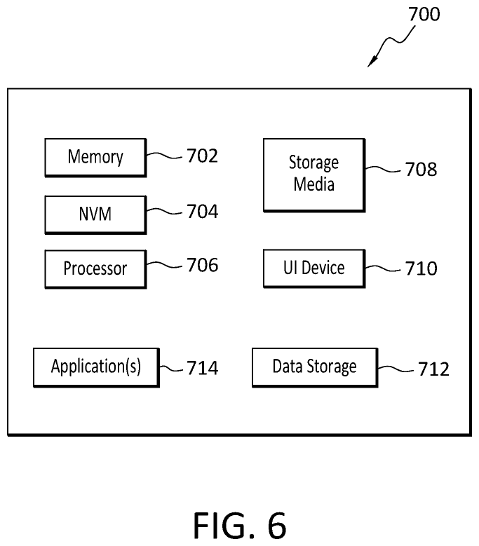

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 6.

In the example of FIG. 6, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a policy layer from a webapp, user information and a database request that identifies a database;
obtaining, by the policy layer, information identifying database access rights for a user who transmitted the database request to the webapp;
generating, by the policy layer, a credential for the user; and
returning, by the policy layer, the credential to either the user or to the webapp.

2. The method as recited in claim 1, wherein the credential includes user privileges.

3. The method as recited in claim 1, wherein when the user uses the credential, the user is granted access to the database, and the access is constrained by user privileges.

4. The method as recited in claim 1, wherein the credential is specific to the user.

5. The method as recited in claim 1, wherein the webapp is configured to use user privilege information in the credential to change what is displayed to, and/or selectable by, the user.

6. The method as recited in claim 1, wherein the information identifying the database privileges is obtained by the policy layer from either the database, or from a centralized identity management system.

7. The method as recited in claim 1, wherein the credential expires automatically after a period of time.

8. The method as recited in claim 1, wherein the credential is generated ad hoc in response to the database request.

9. The method as recited in claim 1, wherein the credential is specific to the user, the webapp, and to the database.

10. The method as recited in claim 1, wherein the webapp makes no determination as to whether or not the user is granted access to the database.

11. A non-transitory storage medium having stored therein instructions that are executable by one or more hardware processors to perform operations comprising:
receiving, by a policy layer from a webapp, user information and a database request that identifies a database;
obtaining, by the policy layer, information identifying database access rights for a user who transmitted the database request to the webapp;
generating, by the policy layer, a credential for the user; and
returning, by the policy layer, the credential to either the user or to the webapp.

12. The non-transitory storage medium as recited in claim 11, wherein the credential includes the user privileges.

13. The non-transitory storage medium as recited in claim 11, wherein when the user uses the credential, the user is granted access to the database, and the access is constrained by the user privileges.

14. The non-transitory storage medium as recited in claim 11, wherein the credential is specific to the user.

15. The non-transitory storage medium as recited in claim 11, wherein the webapp is configured to use user privilege information in the credential to change what is displayed to, and/or selectable by, the user.

16. The non-transitory storage medium as recited in claim 11, wherein the information identifying the database privileges is obtained by the policy layer from either the database, or from a centralized identity management system.

17. The non-transitory storage medium as recited in claim 11, wherein the credential expires automatically after a period of time.

18. The non-transitory storage medium as recited in claim 11, wherein the credential is generated ad hoc in response to the database request.

19. The non-transitory storage medium as recited in claim 11, wherein the credential is specific to the user, the webapp, and to the database.

20. The non-transitory storage medium as recited in claim 11, wherein the webapp makes no determination as to whether or not the user is granted access to the database.
